(19) United States
(12) Patent Application Publication
(10) Pub. No.: US 2017/0315777 A1
(43) Pub. Date: Nov. 2, 2017

(54) METHOD, TERMINAL, AND STORAGE MEDIUM FOR STARTING VOICE INPUT FUNCTION OF TERMINAL

(71) Applicant: TENCENT TECHNOLOGY (SHENZHEN) COMPANY LIMITED, Shenzhen (CN)

(72) Inventors: Wenbo LI, Shenzhen (CN); Xiangping ZHONG, Shenzhen (CN); Bo WEN, Shenzhen (CN); Qi FAN, Shenzhen (CN); Qian CHEN, Shenzhen (CN); Yingfu QIN, Shenzhen (CN); Cheng CHENG, Shenzhen (CN); Kaixiang ZHANG, Shenzhen (CN); Jiajin WANG, Shenzhen (CN)

(21) Appl. No.: 15/652,711

(22) Filed: Jul. 18, 2017

Related U.S. Application Data
(63) Continuation of application No. PCT/CN2016/070347, filed on Jan. 7, 2016.

(30) Foreign Application Priority Data
Jan. 30, 2015 (CN) 201510050858.3

(51) Int. Cl. G06F 3/16

(52) U.S. Cl. CPC G06F 3/167

(57) ABSTRACT

A method, a device and a terminal for starting a voice input function of a terminal are provided. In some embodiments, the method includes performing a proximity detection; in response to detecting an object is in proximity to the terminal, acquiring a distance between the terminal and the object in proximity to the terminal; if the distance is less than a preset threshold, collecting voice data. The user can start the voice input function of the terminal by only moving the terminal to a position in proximity of his mouth, and speaking to a microphone of the terminal. The method is performed easily and is not likely to be performed incorrectly, which improves the efficiency for starting the voice input function of the terminal.

### CROSS REFERENCE TO RELATED APPLICATION

This application is a continuation application of International Application No. PCT/CN2016/070347, titled “METHOD, DEVICE AND TERMINAL FOR STARTING VOICE INPUT FUNCTION OF TERMINAL”, filed on Jan. 7, 2016, which claims priority to Chinese Patent Application No. 201510050858.3, filed on Jan. 30, 2015, both of which are incorporated herein by reference in their entireties.

### TECHNICAL FIELD

The present disclosure relates to the field of terminal technologies and in particular to a method, a terminal and a storage medium for starting a voice input function of a terminal.

### BACKGROUND

At present, an electronic watch has increasing functions, such as voice input function and telephone dialing function. After starting the voice input function of the electronic watch, a user may control the electronic watch to perform operations through the voice input function. For example, after starting the voice input function of the electronic watch, the user says “make a phone call to Zhang San” to the electronic watch, and the electronic watch receives the voice data “make a phone call to Zhang San” through the voice input function, acquires telephone number of Zhang San according to the voice data, and calls the telephone number of Zhang San.

In the electronic watch, the voice input function corresponds to an application icon. When the user wishes to start the voice input function of the electronic watch, the user may click the application icon corresponding to the voice input function in the electronic watch, to trigger a starting command to the electronic watch. When the electronic watch detects the starting instruction, the voice input function of the electronic watch is started.

Generally, the electronic watch has a screen with a small size and the screen needs to display multiple application icons, thus each of the application icons displayed on the screen is small, as such, the user is likely to click on a wrong place on the screen when the user wishes to click the application icon corresponding to the voice input function, and the user needs to click on the screen for multiple times to start the voice input function, which causes a low efficiency for starting voice input function.

### SUMMARY

In order to address above problems, the present disclosure provides a method, a device and a terminal for starting a voice input function of a terminal. The technical solution is described as follows.

In one aspect, a method for starting a voice input function of a terminal is provided according to the disclosure, and the method includes:

performing a proximity detection by the terminal;

acquiring, by the terminal, a distance between the terminal and an object in proximity to the terminal, in response to detecting the object in proximity to the terminal;

collecting, by the terminal, voice data in response to the distance less than a preset threshold; and

starting, by the terminal, a voice input function of the terminal in response to collecting the voice data.

In another aspect, a terminal is provided according to the disclosure, the terminal includes:

a processor; and

a memory, configured to store instructions executable by the processor;

where the processor is configured to:

perform a proximity detection;

acquire a distance between the terminal and an object in proximity to the terminal, in response to detecting the object in proximity to the terminal;

collect voice data in response to the distance less than a preset threshold; and

start the voice input function of the terminal in response to collecting the voice data.

In yet another aspect, a non-transitory computer readable storage medium storing one or more instructions is provided according to the disclosure, and the one or more instructions, when executed by a device, cause the device to:

perform a proximity detection;

acquire a distance between the device and an object in proximity to the device, in response to detecting the object in proximity to the device;

collect voice data in response to the distance less than a preset threshold; and

start a voice input function of the device in response to collecting the voice data.

In the method according to the present disclosure, the proximity detection is performed by the terminal; in response to detecting the object in proximity to the terminal, the distance between the terminal and the object is acquired; the voice data is collected in response to the distance less than the preset threshold; and the voice input function of the terminal is started, in response to collecting the voice data. Since the terminal starts the voice input function in response to collecting the voice data and detecting an object in proximity thereto, the user can start the voice input function of the terminal by only speaking to the microphone of the terminal in proximity of his mouth. The method is performed easily and is not likely to be performed incorrectly, which improves the efficiency for starting the voice input function of the terminal.

### BRIEF DESCRIPTION OF THE DRAWINGS

FIG. 1 is a flowchart of a method for starting a voice input function of a terminal according to a first embodiment of the present disclosure;

FIG. 2-1 is a flowchart of a method for starting a voice input function of a terminal according to a second embodiment of the present disclosure;

FIG. 2-2 is a schematic diagram of moving by a user an electronic watch to a position in proximity of his mouth according to the second embodiment of the present disclosure;

FIG. 2-3 is a schematic diagram of starting an interface for starting a voice input function in an instant messaging chat interface of an electronic watch according to the second embodiment of the present disclosure;

FIG. 2-4 is a schematic diagram of starting an interface for starting a voice input function of an application for voice control in an electronic watch according to the second embodiment of the present disclosure;

FIG. 3 is a structure diagram of a device for starting a voice input function of a terminal according to a third embodiment of the present disclosure; and

FIG. 4 is a structure diagram of a terminal according to a fourth embodiment of the present disclosure.

### DETAILED DESCRIPTION OF THE EMBODIMENTS

In order to illustrate the objects, technical solutions and advantages of the present disclosure more clearly, embodiments of the present disclosure will be described in detail in conjunction with the drawings.

In the specification, claims, and accompanying drawings of the present disclosure, the terms “first”, “second”, “third”, “fourth”, and so on (if existing) are intended to distinguish between similar objects rather than describe a specific order. It should be understood that data used in this way can be exchanged in a proper circumstance, so that the embodiments of the present disclosure can be implemented in other orders except those shown in the figures or described herein.

### First Embodiment

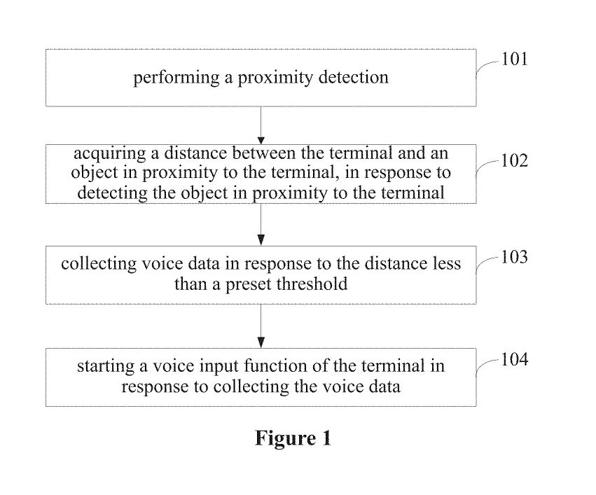

A method for starting a voice input function of a terminal is provided according to an embodiment of the disclosure, and the executive subject of the method is the terminal. As shown in FIG. 1, the method includes steps 101 to 104:

step 101: performing a proximity detection;

step 102: acquiring a distance between the terminal and an object in proximity to the terminal, in response to detecting the object in proximity to the terminal;

step 103: collecting voice data in response to the distance less than a preset threshold; and

step 104: starting a voice input function of the terminal in response to collecting the voice data.

In the method according to the present disclosure, the proximity detection is performed, the distance between the terminal and the object in proximity to the terminal is acquired in response to detecting the object in proximity to the terminal, the voice data is collected in response to the distance less than the preset threshold, and the voice input function of the terminal is started in response to collecting the voice data. Since the terminal starts the voice input function in response to collecting the voice data and detecting an object in proximity thereto, the user can start the voice input function of the terminal by only speaking to a microphone of the terminal in proximity of his mouth. The method is performed easily and is not likely to be performed incorrectly, which improves the efficiency for starting the voice input function of the terminal.

### Second Embodiment

A method for starting a voice input function of a terminal is provided according to an embodiment of the disclosure, the executive subject of the method is the terminal. When a user wishes to start the voice input function of the terminal, the user moves the terminal to a position in proximity of his mouth and speaks to a microphone of the terminal, and the terminal starts the voice input function, in response to: detecting that the distance between the terminal and an object in proximity to the terminal is less than a preset threshold, and collecting voice data.

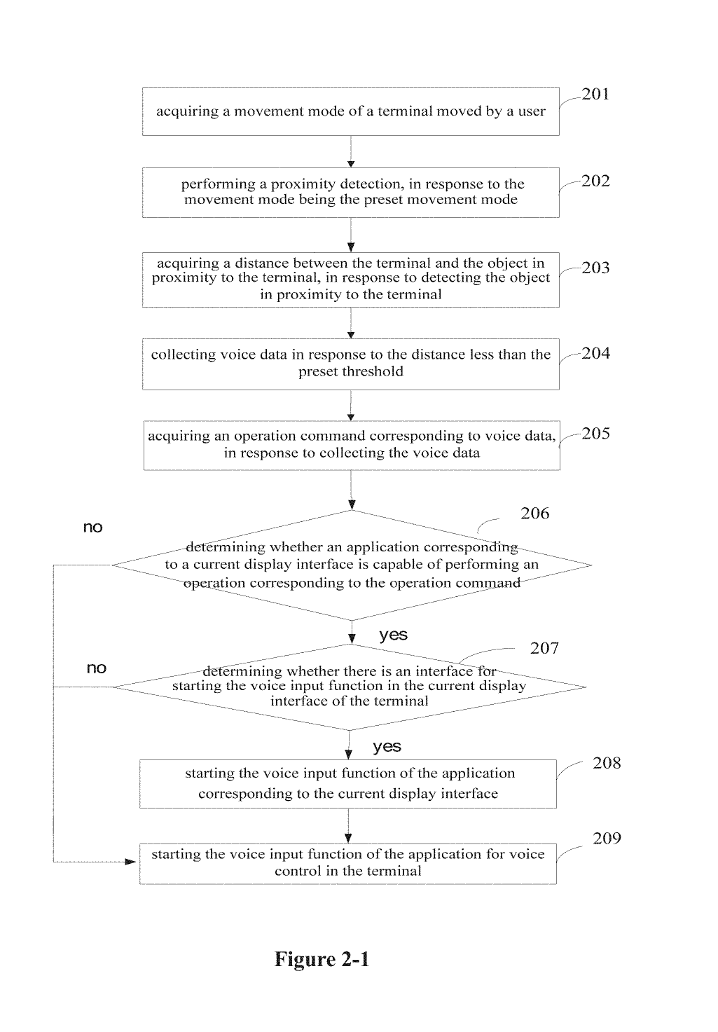

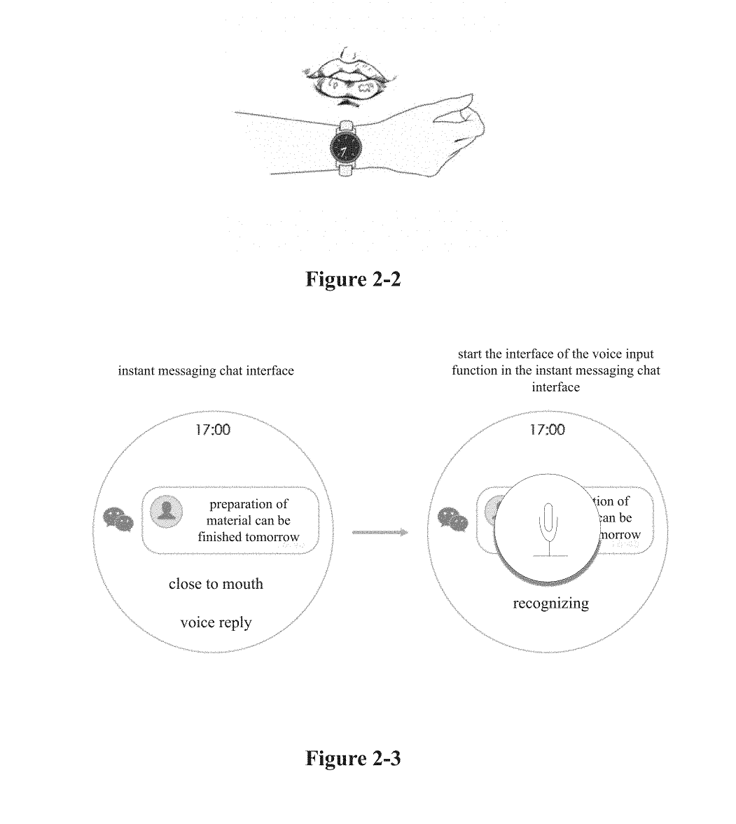

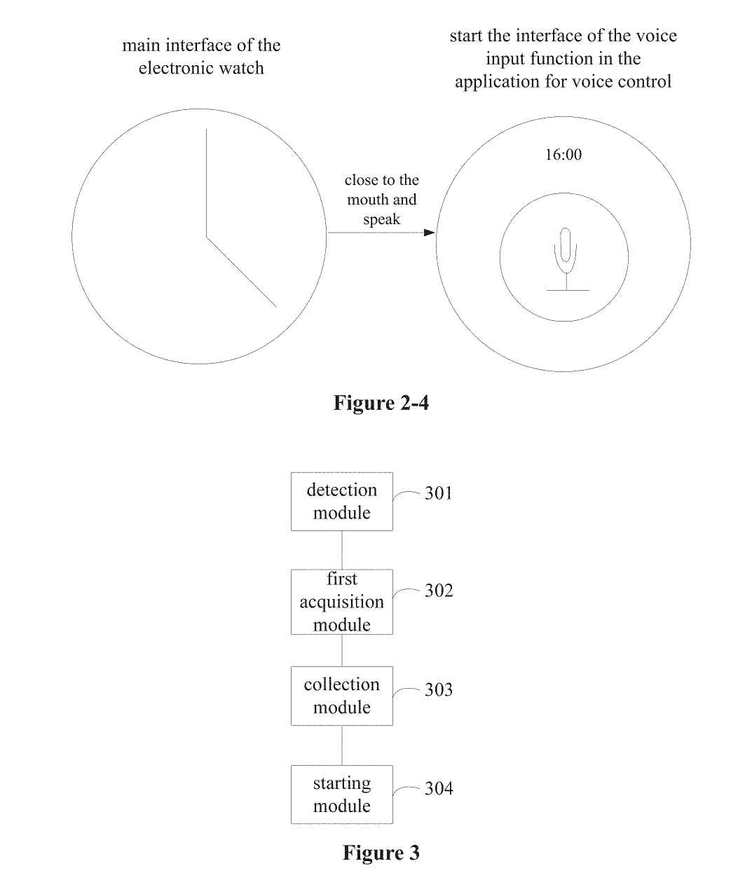

As shown in FIG. 2-1, the method includes steps 201 to 209.

Step 201 includes: acquiring a movement mode of a terminal moved by a user.

In the embodiment of the present disclosure, starting the voice input function of the terminal is triggered by the user moving the terminal to the position in proximity of his mouth and speaking to the terminal. Therefore, in this step, firstly the terminal acquires the movement mode of the terminal moved by the user. If the movement mode is raising the terminal, it is indicated that the user may need to start the voice input function of the terminal. After the movement mode is acquired, the following steps for starting the voice input function are proceeded. Step 201 may be achieved by the following step (1) and step (2).

Step (1) includes: acquiring movement information of the terminal moved by the user.

The movement information includes a movement direction and a movement distance of the terminal, which are obtained by a distance sensor of the terminal. Alternatively, the direction of movement is determined by other sensors such as a gravity sensor.

Step (2) includes: determining the movement mode of the terminal moved by the user based on the movement information.

The terminal pre-determines each movement mode and a corresponding movement condition that the terminal satisfies in the movement mode. The movement condition that the terminal satisfies is determined according to the movement information. The movement mode of the terminal moved by the user is acquired according to the determined movement condition.

For example, when the user moves the terminal to the position in proximity of his mouth, the user needs to raise the terminal up for a predetermined distance, that is, the movement mode of the terminal moved by the user is raising the terminal. It is predetermined that the movement condition corresponding to raising the terminal includes that a movement direction of the terminal moved by the user is upward and a distance for moving the terminal is greater than or equal to a movement distance threshold. The movement distance threshold may be 15 centimeters, 20 centimeters or 25 centimeters, etc. It is assumed that the movement distance is predetermined as 20 centimeters.

The movement information of the terminal moved by the user is acquired. It is assumed that the movement information includes an upward direction and a movement distance of 30 centimeters, and based on the movement information, it is determined that the moving condition corresponding to raising the terminal is satisfied, thus raising the terminal is determined as the movement mode of the terminal moved by the user.

Whether the movement mode is a preset movement mode is determined after acquiring the movement mode of the terminal moved by the user, step 203 is proceeded if the movement mode is the preset movement mode; and the method is ended if the movement mode is not the preset movement mode. The preset movement mode is raising the terminal.

The terminal may be a mobile phone, a tablet computer or an electronic watch, etc. Taking that the terminal is an electronic watch as an example for illustration, when the user wishes to start the voice input function of the electronic watch, the user raises the electronic watch to the position in proximity of his mouth, and as shown in FIG. 2-2, the electronic watch determines that the movement mode of the electronic watch is raising a hand. The preset movement mode may be set and changed as required. In the embodiment of the present disclosure, the preset movement mode is not limited.

Step 202 includes: performing a proximity detection, in response to the movement mode being the preset movement mode.

The preset movement mode may be raising the terminal.

A distance sensor is included in the terminal, it may be defined that a direction in which the distance sensor transmits a signal is a front direction of the terminal. If the movement mode is the preset movement mode, the detection is performed by the distance sensor of the terminal in front of the terminal to detect whether there is an object in front of the terminal. It is indicated that the user may move the terminal to the position in proximity of his mouth if there is the object. If the movement mode is not the preset movement mode, it is indicated that the user does not wishes to start the voice input function, and the method is ended.

The distance sensor is capable of emitting light pulses. If there is an object in front of the terminal, the light pulses may be reflected by the object and received by the distance sensor. Thus the distance sensor detects the object in front of the terminal when receiving the reflected light pulses. It should be noted that, in the present embodiment, the light pulses have a short transmission distance. For example the transmission distance of the optical pulses is 50 centimeters, 60 centimeters or 70 centimeters.

Step 203 includes: acquiring a distance between the terminal and the object in proximity to the terminal, in response to detecting the object in proximity to the terminal.

In response to detecting the object in proximity to the terminal, that is, in response to receiving the reflected light pulses by the distance sensor of the terminal, the transmitting time of the light pulses and the receiving time of the light pulses are acquired. Based on the transmitting time and the receiving time, the distance between the terminal and the object in proximity to the terminal is calculated according to the following formula:

s=(t2−t1)*c, where s is the distance between the terminal and the object in proximity to the terminal, t2 is the receiving time, t1 is the transmitting time and c is the speed of light.

When the user wishes to start the voice input function of the terminal, the user needs to move the terminal to the position in proximity of his mouth so that the distance between the terminal and the mouth of the user is small. Therefore in this embodiment, after acquiring the distance between the terminal and the object in proximity to the terminal, whether the distance is less than a preset threshold may be determined. If the distance is less than the preset threshold, it is indicated that the user may raise the terminal to the position in proximity of his mouth and the subsequent step of starting the voice input function is proceeded; if the distance is greater than or equal to the preset threshold, it is indicated that the user does not move the terminal to the position in proximity of his mouth, such that it is determined that the user does not wishes to start the voice input function of the terminal, and the method is ended.

The preset threshold may be set and changed as required. In the embodiment of the present disclosure, the preset threshold is not limited.

Step 204 includes: collecting voice data in response to the distance less than the preset threshold.

If the distance is less than the preset threshold, it is determined that the user may move the terminal to the position in proximity of his mouth. In this case, the voice data is collected by a microphone of the terminal. If the voice data is collected, it is determined that the user wishes to start the voice input function of the terminal, and step 205 is proceeded; if the voice data is not collected, it is determined that the user does not wishes to start the voice input function of the terminal. The method is ended.

Step 205 includes: acquiring an operation command corresponding to voice data, in response to collecting the voice data.

If the voice data is collected, it is determined that the user may wish to start the voice input function of the terminal, a content of the voice data is collected, and the operation command corresponding to the voice data is acquired according to the content of the voice data.

A set of data contents is defined in advance. The set of data contents includes at least one data content and each of the data contents in the set of data contents corresponds to an operation command. In this step, based on the content of the voice data, the step of acquiring an operation command corresponding to the voice data may comprises:

determining whether the set of data contents includes a data content matching with the content of the voice data according to the content of the voice data. If the set of data contents includes the data content matching with the content of the voice data, acquiring an operation command corresponding to the data content and using the operation command corresponding to the data content as the operation command corresponding to the voice data; if the set of data contents does not include data content matching with the content of the voice data, it is determined that there is no operation command corresponding to the voice data, and step 207 is directly proceeded.

For example, after moving the electronic watch to the position in proximity of his mouth, the user says to the microphone of the electronic watch: “reply”. The content of the voice data acquired by the electronic watch is “reply”, and an operation command corresponding to the voice data is acquired as “reply” according to the content of the voice data “reply”.

Step 206 includes: determining whether an application corresponding to a current display interface is capable of performing an operation corresponding to the operation command. If yes, step 207 is proceeded, and if no, step 209 is proceeded.

A set of operation commands corresponding to each application is predetermined, and the set of operation commands is configured to store the operation commands executable by the application. According to the current display interface corresponding to the application, the set of operation commands corresponding to the application is acquired, and whether the operation command is included in the set of operation commands corresponding to the application is determined, if the set of operation commands includes the operation command, it is determined that the application corresponding to the current display interface can execute the operation corresponding to the operation command, and step 207 is proceeded. If the set of operation commands does not include the operation command, it is determined that the application corresponding to the current display interface can not execute the operation corresponding to the operation command, and the step 209 is proceeded.

For example, the current display interface is an instant messaging chat interface, and the application corresponding to the current display interface is an instant messaging application. A set of operation commands corresponding to the instant messaging application is acquired, and the set of operation commands includes commands such as “reply, chat, contact, and speak, etc.” Based on the operation command “reply” corresponding to the voice data, it is determined that the operation command “reply” is included in the set of operation commands of the instant messaging application, such that it is determined that the instant messaging application can execute the operation corresponding to the operation command, and step 207 is proceeded.

Step 207 includes: determining whether there is an interface for starting the voice input function in the current display interface of the terminal; proceeding step 208, if there is the interface for starting the voice input function in the current display interface of the terminal; and proceeding step 209, if there is no interface for starting the voice input function in the current display interface of the terminal.

Whether the current display interface of the terminal includes the interface for starting the voice input function is detected, if the interface for starting the voice input function is included in the current display interface of the terminal, it is determined that the user wishes to start the voice input function in the application corresponding to the current display interface, and step 208 is proceeded. If there is no interface for starting the voice input function in the current display interface of the terminal, it is determined that the user wishes to start the voice input function of an application for voice control in the terminal.

For example, the current display interface is an instant messaging chat interface and the instant messaging chat interface includes an interface for starting the voice input function, in this case, step 208 is proceeded

Step 208 includes: starting the voice input function of the application corresponding to the current display interface, and ending the method.

The interface for starting the voice input function in the current display interface is activated to start the voice input function in the application corresponding to the current display interface.

For example, as shown in FIG. 2-3, the electronic watch activates the interface for starting the voice input function in the instant communication chat interface.

Step 209 includes: starting the voice input function of the application for voice control in the terminal.

The application for voice control in the terminal is started, and the interface for starting the voice input function included in the application for voice control is activated, so as to start the voice input function of the application for voice control in the terminal.

The application for voice control is an application for performing voice control on the terminal, such as a siri application, etc. The user can control the terminal to perform an operation through the application for voice control in the terminal.

For example, as shown in FIG. 2-4, the electronic watch starts the voice input function of the application for voice control in the electronic watch.

According to the present disclosure, the proximity detection is performed by the terminal; in response to detecting the object in proximity to the terminal, the distance between the terminal and the object is acquired; the voice data is collected in response to the distance less than the preset threshold; and the voice input function of the terminal is started, in response to collecting the voice data. Since the terminal starts the voice input function in response to collecting the voice data and detecting an object in proximity thereto, the user can start the voice input function of the terminal by only speaking to the microphone of the terminal in proximity of his mouth. The method is performed easily and is not likely to be performed incorrectly, which improves the efficiency for starting the voice input function of the terminal.

### Third Embodiment

A device for starting a voice input function of a terminal is provided according to an embodiment of the disclosure. As shown in FIG. 3, the device includes:

a detection module 301, configured to perform a proximity detection;

a first acquisition module 302, configured to acquire a distance between the terminal and an object in proximity to the terminal, in response to detecting the object in proximity to the terminal;

a collection module 303, configured to collect voice data in response to the distance less than a preset threshold; and

a starting module 304 configured to start the voice input function of the terminal in response to collecting the voice data.

The starting module 304 further includes:

a first determination unit, configured to determine whether a current display interface of the terminal includes an interface for starting the voice input function;

a first starting unit, configured to start the voice input function in the application corresponding to the current display interface if the current display interface of the terminal includes the interface for starting the voice input function; and

a second starting unit, configured to start the voice input function of the application for voice control in the terminal if there is no interface for starting the voice input function.

The starting module 304 further includes:

a first acquisition unit, configured to acquire an operation command corresponding to the voice data;

a second determination unit, configured to:

determine whether the application corresponding to the current display interface is capable of performing the operation corresponding to the operation command; and

determine whether the current display interface of the terminal includes the interface for starting the voice input function, if the application corresponding to the current display interface is capable of executing the operation corresponding to the operation command; and

a third starting unit, configured to start the voice input function of the application for voice control in the terminal if the application is not capable of performing the operation corresponding to the operating command.

The device further includes:

a second acquisition module, configured to:

acquire a movement mode of the terminal moved by the user; and

perform the proximity detection, if the movement mode is a preset movement mode.

The second acquisition module further includes:

a second acquisition unit, configured to acquire movement information of the terminal moved by the user; and

a determination unit, configured to determine the movement mode of the terminal moved by the user based on the movement information.

According to the present disclosure, the proximity detection is performed, the distance between the terminal and the object in proximity to the terminal is acquired in response to detecting the object in proximity to the terminal, the voice data is collected in response to the distance less than the preset threshold, and the voice input function of the terminal is started in response to collecting the voice data. Since the terminal starts the voice input function in response to collecting the voice data and detecting an object in proximity thereto, the user can start the voice input function of the terminal by only speaking to a microphone of the terminal in proximity of his mouth. The method is performed easily and is not likely to be performed incorrectly, which improves the efficiency for starting the voice input function of the terminal.

### Fourth Embodiment

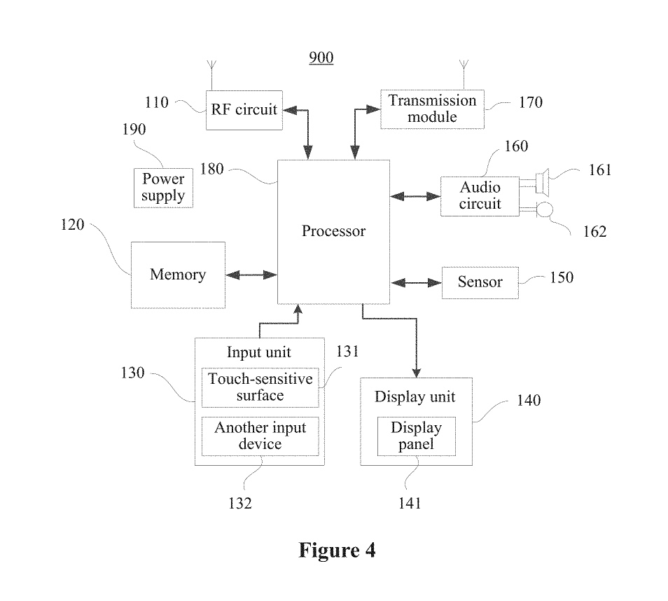

FIG. 4 shows a schematic structure diagram of a terminal with a touch-sensitive surface according to an embodiment of the present disclosure. The terminal is configured to perform the method for starting a voice input function of a terminal according to the above embodiment.

Specifically, the terminal 900 may include a radio frequency (RF) circuit 110, a memory 120 including one or more computer-readable storage media, an input unit 130, a display unit 140, a sensor 150, an audio circuit 160, a wireless fidelity (WiFi) module 170, a processor 180 including one or more processing cores and a power supply 190, etc. A person skilled in the art may understand that the structure of the terminal shown in FIG. 4 does not constitute a limitation to the terminal, and the terminal may include more components or fewer components than those shown in the figure, or some components may be combined, or a different component deployment may be used.

The RF circuit 110 may be configured to receive and send signals during an information receiving and sending process or a call process. Particularly, the RF circuit 110 receives downlink information from a base station, then delivers the downlink information to one or more processors 180 for processing, and sends related uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 110 may also communicate with a network and another device by wireless communication. The wireless communication may use any communications standard or protocol, which includes, but is not limited to, Global System for Mobile communications (GSM), General Packet Radio Service (GPRS), Code Division Multiple Access (CDMA), Wideband Code Division Multiple Access (WCDMA), Long Term Evolution (LTE), e-mail, Short Messaging Service (SMS), and the like.

The memory 120 may be configured to store a software program and module. The processor 180 runs the software program and module stored in the memory 120, to implement various functional applications and data processing. The memory 120 may mainly include a program storage area and a data storage area. The program storage area may store an operating system, an application program required by at least one function (such as a sound playback function and an image playback function), and the like. The data storage area may store data (such as audio data and an address book) created according to use of the terminal 900, and the like. In addition, the memory 120 may include a high speed random access memory, and may also include a non-volatile memory such as at least one magnetic disk storage device, a flash memory, or another volatile solid-state storage device. Correspondingly, the memory 120 may include a memory controller, to provide access of the processor 180 and the input unit 130 to the memory 120.

The input unit 130 may be configured to receive input digit or character information, and generate a keyboard, mouse, joystick, optical, or track ball signal input related to the user setting and function control. Specifically, the input unit 130 may include a touch-sensitive surface 131 and another input device 132. The touch-sensitive surface 131, which may also be referred to as a touch screen or a touch panel, may collect a touch operation of a user on or near the touch-sensitive surface (such as an operation of a user on or near the touch-sensitive surface 131 by using any suitable object or accessory, such as a finger or a stylus), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives touch information from the touch detection apparatus, converts the touch information into touch point coordinates, and sends the touch point coordinates to the processor 180. Moreover, the touch controller can receive and execute a command sent from the processor 180. In addition, the touch-sensitive surface 131 may be a resistive, capacitive, infrared, or surface sound wave type touch-sensitive surface. In addition to the touch-sensitive surface 131, the input unit 130 may further include another input device 132. Specifically, the another input device 132 may include, but is not limited to, one or more of a physical keyboard, a functional key (such as a volume control key or a switch key), a track ball, a mouse, and a joystick.

The display unit 140 may be configured to display information input by the user or information provided for the user, and various graphical user interfaces of the terminal 900. The graphical user interfaces may be formed by a graph, a text, an icon, a video, or any combination thereof. The display unit 140 may include a display panel 141. Optionally, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 131 transfers the touch operation to the processor 180, so as to determine the type of the touch event. Then, the processor 180 provides a corresponding visual output on the display panel 141 according to the type of the touch event. Although, in FIG. 4, the touch-sensitive surface 131 and the display panel 141 are used as two separate parts to implement input and output functions, in some embodiments, the touch-sensitive surface 131 and the display panel 141 may be integrated to implement the input and output functions.

The terminal 900 may further include at least one sensor 150, such as an optical sensor, a motion sensor, and other sensors. Specifically, the optical sensor may include an ambient light sensor and a proximity sensor. The ambient light sensor can adjust luminance of the display panel 141 according to brightness of the ambient light. The proximity sensor may switch off the display panel 141 and/or backlight when the terminal 900 is moved to the ear. As one type of motion sensor, a gravity acceleration sensor can detect magnitude of accelerations in various directions (generally on three axes), may detect magnitude and a direction of the gravity when static, and may be applied to an application that recognizes the attitude of the mobile phone (for example, switching between landscape orientation and portrait orientation, a related game, and magnetometer attitude calibration), a function related to vibration recognition (such as a pedometer and a knock), and the like. Other sensors, such as a gyroscope, a barometer, a hygrometer, a thermometer, and an infrared sensor, which may be configured in the terminal 900, are not further described herein.

The audio circuit 160, a loudspeaker 161, and a microphone 162 may provide audio interfaces between the user and the terminal 900. The audio circuit 160 may convert received audio data into an electric signal and transmit the electric signal to the loudspeaker 161. The loudspeaker 161 converts the electric signal into a sound signal for output. On the other hand, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another terminal device by using the RF circuit 110, or outputs the audio data to the memory 120 for further processing. The audio circuit 160 may further include an earplug jack, so as to provide communication between a peripheral earphone and the terminal 900.

WiFi is a short-distance wireless transmission technology, the terminal 900 may help, by using the transmission module 170, the user to receive and send e-mails, browse a webpage, access streaming media, and so on, which provides wireless or wired broadband Internet access for the user. Although FIG. 4 shows the transmission module 170, it may be understood that the transmission module is not a necessary component of the terminal 900, and when required, the transmission module may be omitted as long as the scope of the essence of the present disclosure is not changed.

The processor 180 is the control center of the terminal 900, and is connected to various parts of the mobile phone by using various interfaces and lines. By running or executing the software program and/or module stored in the memory 120, and invoking data stored in the memory 120, the processor 180 performs various functions and data processing of the terminal 900, thereby performing overall monitoring on the mobile phone. Optionally, the processor 180 may include one or more processing cores. Preferably, the processor 180 may integrate an application processor and a modem. The application processor mainly processes an operating system, a user interface, an application program, and the like. The modem mainly processes wireless communication. It may be understood that the foregoing modem may also not be integrated into the processor 180.

The terminal 900 further includes the power supply 190 (such as a battery) for supplying power to the components. Preferably, the power supply may be logically connected to the processor 180 by using a power management system, thereby implementing functions such as charging, discharging and power consumption management by using the power management system. The power supply 190 may further include one or more of a direct current or alternating current power supply, a re-charging system, a power failure detection circuit, a power supply converter or inverter, a power supply state indicator, and any other components.

Although not shown in the figure, the terminal 900 may further include a camera, a Bluetooth module, and the like, which are not further described herein. Specifically, in this embodiment, the display unit of the terminal is a touch screen monitor, and the terminal further includes a memory and one or more programs. The one or more programs are stored in the memory and configured to be executed by one or more processors. The one or more programs contain instructions for performing the following operations:

performing a proximity detection;

acquiring a distance between the terminal and an object in proximity to the terminal, in response to detecting the object in proximity to the terminal;

collecting voice data in response to the distance less than a preset threshold; and

starting the voice input function of the terminal in response to collecting the voice data.

Further, the starting the voice input function of the terminal includes:

determining whether a current display interface of the terminal includes an interface for starting the voice input function;

starting the voice input function in the application corresponding to the current display interface, if the current display interface of the terminal includes the interface for starting the voice input function; and

starting the voice input function of an application for voice control in the terminal if there is no interface for starting the voice input function in the current display interface.

Before determining whether the current display interface of the terminal includes the interface for starting the voice input function, the operations further include:

acquiring an operation command corresponding to the voice data;

determining whether the application corresponding to the current display interface is capable of executing the operation corresponding to the operation command;

performing the step of determining whether the current display interface of the terminal includes the interface for starting the voice input function, if the application corresponding to the current display interface is capable of executing the operation corresponding to the operation command; and

starting the voice input function of the application for voice control in the terminal, if the application corresponding to the current display interface is not capable of executing the operation corresponding to the operation command

Before performing the proximity detection, the operations further include:

acquiring a movement mode of the terminal moved by a user and

performing the step of performing the proximity detection if the movement mode is a preset movement mode.

Furthermore, the acquiring the movement mode of the terminal moved by the user includes:

acquiring movement information of the terminal moved by the user; and

determining the movement mode of the terminal moved by the user based on the movement information.

According to the present disclosure, the proximity detection is performed by the terminal; in response to detecting the object in proximity to the terminal, the distance between the terminal and the object is acquired; the voice data is collected in response to the distance less than the preset threshold; and the voice input function of the terminal is started, in response to collecting the voice data. Since the terminal starts the voice input function in response to collecting the voice data and detecting an object in proximity thereto, the user can start the voice input function of the terminal by only speaking to the microphone of the terminal in proximity of his mouth. The method is performed easily and is not likely to be performed incorrectly, which improves the efficiency for starting the voice input function of the terminal.

It should be noted that the device for starting the voice input function of the terminal is only described using the above functional modules for exemplary purposes when the voice input function of the terminal provided by the foregoing embodiments is started. In actual applications, the functions may be allocated to different functional modules according to specific needs, which means that the device is divided to different functional modules to complete all or some of the above described functions. In addition, the terminal, the device for starting the voice input function of the terminal is based on the same concept as the method for starting the voice input function of the terminal in the foregoing embodiments. For the specific implementation process, refer to the method embodiments, and the details are not described herein again.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing describes some embodiments of the present disclosure, but are not intended to limit the present disclosure. Any modification, equivalent replacement, or improvement made within the spirit and principle of the present disclosure shall fall within the protection scope of the present disclosure.

1. A method for starting a voice input function of a terminal comprising a processor, the method comprising:
performing proximity detection by the terminal;
acquiring, by the terminal, a distance between the terminal and an object in proximity to the terminal in response to detecting the object in proximity to the terminal;
collecting, by the terminal, voice data in response to determining that the distance is less than a preset threshold; and
starting, by the terminal, a voice input function of the terminal in response to collecting the voice data.

2. The method according to claim 1, wherein starting by the terminal the voice input function of the terminal comprises:
determining, by the terminal, whether a current display interface of the terminal comprises an interface for starting the voice input function;
starting, by the terminal, the voice input function of an application corresponding to the current display interface if the current display interface of the terminal comprises the interface for starting the voice input function; and
starting the voice input function of an application for voice control in the terminal if the current display interface of the terminal does not comprise the interface for starting the voice input function.

3. The method according to claim 2, wherein starting by the terminal the voice input function of the terminal comprises:
acquiring, by the terminal, an operation command corresponding to the voice data; and
determining, by the terminal, whether the application corresponding to the current display interface is capable of performing an operation corresponding to the operation command;
determining, by the terminal, whether the current display interface of the terminal comprises the interface for starting the voice input function if the application corresponding to the current display interface is capable of performing the operation; and
starting, by the terminal, the voice input function of the application for voice control in the terminal if the application corresponding to the current display interface is not capable of performing the operation.

4. The method according to claim 3, wherein the terminal determines a set of data contents each corresponding to the operation command in advance, and
acquiring, by the terminal, the operation command corresponding to the voice data comprises:
determining, by the terminal, whether the set of data contents comprises a data content matching with the content of the voice data;
acquiring, by the terminal, the operation command corresponding to the data content and determining the operation command corresponding to the data content as the operation command corresponding to the voice data if the set of data content comprises the data content matching with the content of the voice data; and
determining, by the terminal, that the application corresponding to the current display interface is not capable of performing the operation corresponding to the operation command if the set of data contents does not comprises the data content matching with the content of the voice data.

5. The method according to claim 3, the terminal predetermines a set of operation commands corresponding to each application, and
determining, by the terminal, whether the application corresponding to the current display interface is capable of performing the operation corresponding to the operation command comprises:
determining, by the terminal, whether the set of operation commands corresponding to each application comprises the operation command corresponding to the voice data;
determining, by the terminal, that the application corresponding to the current display interface is capable of executing the operation corresponding to the operation command if the set of operation commands corresponding to each application comprises the operation command corresponding to the voice data; and
determining, by the terminal, that the application corresponding to the current display interface is not capable of executing the operation corresponding to the operation command if the set of operation commands corresponding to each application does not comprise the operation command corresponding to the voice data.

6. The method according to claim 1, wherein performing, by the terminal, the proximity detection comprises:
acquiring, by the terminal, a movement mode of the terminal moved by a user; and
performing, by the terminal, the proximity detection in response to the movement mode being a preset movement mode.

7. The method according to claim 6, wherein acquiring, by the terminal, the movement mode of the terminal moved by the user, comprises:
acquiring, by the terminal, movement information of the terminal moved by the user; and
determining, by the terminal, the movement mode of the terminal moved by the user based on the movement information.

8. The method according to claim 7, wherein the terminal pre-determines a corresponding movement condition that the terminal satisfies in each movement mode, and
determining, by the terminal, the movement mode of the terminal moved by the user based on the movement information comprises:
determining a movement condition that the terminal satisfies according to the movement information, and
determining the movement mode of the terminal based on the determined movement condition.

9. The method according to claim 8, wherein the movement information comprises a movement direction and a movement distance of the terminal.

10. A terminal, comprising:
a processor;
a memory, configured to store instructions executable by the processor;
wherein the processor is configured to:
perform proximity detection;
acquire a distance between the device and an object in proximity to the device in response to detecting the object in proximity to the device;
collect voice data in response to a determination that the distance is less than a preset threshold; and
start a voice input function of the device in response to collecting the voice data.

11. The terminal according to claim 10, wherein the processor is further configured to:
determine whether a current display interface of the terminal comprises an interface for starting the voice input function;
start the voice input function in an application corresponding to the current display interface if the current display interface of the terminal comprises the interface for starting the voice input function; and
start the voice input function of an application for voice control in the terminal if the current display interface of the terminal does not comprise the interface for starting the voice input function.

12. The terminal according to claim 11, wherein the processor is further configured to:
acquire an operation command corresponding to the voice data;
determine whether the application corresponding to the current display interface is capable of executing the operation corresponding to the operation command;
determine whether the current display interface of the terminal comprises the interface for starting the voice input function if the application is capable of executing the operation; and
start the voice input function of the application for voice control in the terminal if the application is not capable of performing the operation.

13. The terminal according to claim 12, wherein the processor is further configured to:
determine a set of data contents each corresponding to the operation command in advance;
determine whether the set of data contents comprises a data content matching with the content of the voice data;
acquire the operation command corresponding to the data content and determining the operation command corresponding to the data content as the operation command corresponding to the voice data if the set of data content comprises the data content matching with the content of the voice data; and
determine that the application corresponding to the current display interface is not capable of performing the operation corresponding to the operation command if the set of data contents does not comprises the data content matching with the content of the voice data.

14. The terminal according to claim 12, wherein the processor is further configured to:
predetermine a set of operation commands corresponding to each application;
determine whether the set of operation commands corresponding to each application comprises the operation command corresponding to the voice data;
determine that the application corresponding to the current display interface is capable of executing the operation corresponding to the operation command if the set of operation commands corresponding to each application comprises the operation command corresponding to the voice data; and
determine that the application corresponding to the current display interface is not capable of executing the operation corresponding to the operation command if the set of operation commands corresponding to each application does not comprise the operation command corresponding to the voice data.

15. The terminal according to claim 10, wherein the processor is further configured to:
acquire a movement mode of the terminal moved by a user; and
perform the proximity detection if the movement mode is a preset movement mode.

16. The terminal according to claim 15, wherein the processor is further configured to:
acquire the movement information of the terminal moved by the user; and
determine the movement mode of the terminal moved by the user based on the movement information

17. The terminal according to claim 16, wherein the processor is further configured to:
pre-determine a corresponding movement condition that the terminal satisfies in each movement mode;
determine a movement condition that the terminal satisfies according to the movement information, and
determine the movement mode of the terminal based on the determined movement condition.

18. The terminal according to claim 17, wherein the movement information comprises a movement direction and a movement distance of the terminal.

19. A non-transitory computer readable storage medium storing one or more instructions, which, when executed by a device comprising a processor, configure the device to:
perform proximity detection;
acquire a distance between the device and an object in proximity to the device, in response to detecting the object in proximity to the device;
collect voice data in response to a determination that the distance is less than a preset threshold; and
start a voice input function of the device in response to collecting the voice data.
